(19) United States
(12) Patent Application Publication
(10) Pub. No.: US 2026/0005755 A1
(43) Pub. Date: Jan. 1, 2026

(54) ELECTROMAGNETIC WAVE INFORMATION PROCESSING DEVICE AND ELECTROMAGNETIC WAVE INFORMATION PROCESSING METHOD

(71) Applicant: Hitachi, Ltd., Tokyo (JP)

(72) Inventors: Tsukasa FUNANE, Tokyo (JP); Yosuke TANABE, Tokyo (JP); Hisatoshi KIMURA, Tokyo (JP); Makoto ITO, Tokyo (JP); Koichi WATANABE, Tokyo (JP)

(21) Appl. No.: 19/224,963

(22) Filed: Jun. 2, 2025

(30) Foreign Application Priority Data
Jun. 28, 2024 (JP) 2024-104568

(51) Int. Cl. H04B 7/185

(52) U.S. Cl. CPC H04B 7/18554; H04B 7/18519

(57) ABSTRACT

An electromagnetic wave information processing device includes an input unit configured to receive a measurement result that measures electromagnetic waves incident on a spacecraft from substantially an omnidirection. A calculation is performed based on information received by the input unit; and an output unit is configured to output a calculation result. The calculation is based on the measurement result received by the input unit, a local omnidirectional feature which is a coefficient of a local basis function indicating a distribution of the electromagnetic waves received by the input unit in a spacecraft coordinate system centered on the spacecraft at a predetermined position in an outer space, and an entire omnidirectional feature which is a coefficient of an entire basis function based on local omnidirectional features and the predetermined positions, thereby generating a map indicating a distribution of an entire electromagnetic wave source including a ground surface and the outer space.

### CLAIM OF PRIORITY

The present application claims priority from Japanese Patent application serial no. 2024-104568, filed on Jun. 28, 2024, the content of which is hereby incorporated by reference into this application.

### BACKGROUND OF THE INVENTION

### 1. Field of the Invention

The present invention relates to a configuration of an electromagnetic wave information processing device and a method thereof, and more particularly to a technique effectively applied to processing of electromagnetic wave information distributed in an omnidirection on the earth and in the outer space.

### 2. Description of Related Art

An electromagnetic wave arrival direction determining method by observing a phase difference or the like in interferometry processing using signals received by a plurality of antennas has been proposed. For example, there is radio wave astronomical observation in which a radio wave source in a specific limited field of view is observed by radio wave measurement or radio wave interferometry measurement on the ground. In addition, there is a method for observing a radio wave source on the earth surface using an arrival time difference, interference, or the like of radio waves received by satellites flying in formation or a plurality of antennas of a single satellite.

As a background art of the technical field, for example, there is a technique as disclosed in PTL 1. PTL 1 discloses “a method for estimating a relative arrival direction of a target signal by an antenna array of a spacecraft on an earth orbit”.

### CITATION LIST

### Patent Literature

PTL 1: U.S. Patent Application Publication No. 2015/0355312

### SUMMARY OF THE INVENTION

In a field of space situational awareness, it is important to quickly grasp and update radio wave source information in an “omnidirection” defined in any direction in a range of an azimuth angle of 0 degrees to 360 degrees and an elevation angle (or depression angle) of −90 degrees to 90 degrees.

However, in the related art including PTL 1, a method for treating an electromagnetic wave source distribution in any direction measured from a single point (for example, an antenna on the ground or an artificial satellite) as local omnidirectional feature information or a method for effectively performing projection or conversion on an entire celestial sphere surface centered on the earth (that is, a geocentric celestial sphere surface) at low cost is not known.

For example, radio wave astronomy generally targets a specific celestial body direction, and the celestial body direction cannot be projected or converted onto the entire celestial sphere surface (that is, the geocentric celestial sphere surface) centered on the earth.

In addition, when the radio wave source on the earth surface in the vicinity of a satellite is observed by the satellites flying in formation, since a measurement target is in a direction directly below the satellite, an electromagnetic wave distribution on the entire ground surface is not estimated, and an electromagnetic wave distribution in a direction of the geocentric celestial sphere surface (space side) cannot be measured.

Further, even when the projection and estimation are performed in the omnidirection, a measurement time and a data amount are enormous, on-board processing is difficult, and such a projection and estimation method is not known. In addition, it is not known to perform entire estimation based on local measurement data.

Therefore, an object of the invention is to provide an electromagnetic wave information processing device and an electromagnetic wave information processing method capable of projecting measurement and estimation information of electromagnetic waves distributed in an omnidirection on the earth and in the outer space onto an entire celestial sphere surface or an entire ground surface effectively and at low cost through acquisition of local omnidirectional feature information, and further capable of estimating the entire (entire celestial sphere surface and entire ground surface) data from local data.

In order to solve the above problem, the invention includes: an input unit configured to receive a measurement result from a measurement unit that measures electromagnetic waves incident on a spacecraft from substantially an omnidirection; a calculation unit configured to perform calculation based on information received by the input unit; and an output unit configured to output a calculation result in the calculation unit. The calculation unit calculates, based on the measurement result received by the input unit, a local omnidirectional feature which is a coefficient of a local basis function indicating a distribution of the electromagnetic waves received by the input unit in a spacecraft coordinate system centered on the spacecraft at a predetermined position in an outer space, and calculates an entire omnidirectional feature which is a coefficient of an entire basis function based on a plurality of the local omnidirectional features and information of a plurality of the predetermined positions in the outer space, thereby generating a map indicating a distribution of an entire electromagnetic wave source including a ground surface and the outer space. The output unit outputs the map.

The invention is an electromagnetic wave information processing device mounted on a spacecraft. The electromagnetic wave information processing device includes: a measurement unit configured to measure electromagnetic waves incident from a substantially omnidirection; a calculation unit configured to perform calculation based on information measured by the measurement unit; and an output unit configured to output a calculation result in the calculation unit. The calculation unit calculates, based on an electromagnetic wave measurement result measured by the measurement unit, a local omnidirectional feature which is a coefficient of a local basis function indicating a distribution of the electromagnetic waves measured by the measurement unit in a spacecraft coordinate system centered on the spacecraft at a predetermined position in an outer space, and calculates an entire omnidirectional feature which is a coefficient of an entire basis function based on a plurality of the local omnidirectional features and information of a plurality of the predetermined positions in the outer space, thereby generating a map indicating a distribution of an entire electromagnetic wave source including a ground surface and the outer space. The output unit outputs the map.

The invention includes: (a) a step of calculating, by a calculation unit, based on an electromagnetic wave measurement result measured by a measurement unit, a local omnidirectional feature which is a coefficient of a local basis function indicating a distribution of electromagnetic waves measured by the measurement unit in a spacecraft coordinate system centered on a spacecraft at a predetermined position in an outer space; (b) a step of calculating an entire omnidirectional feature which is a coefficient of an entire basis function based on a plurality of the local omnidirectional features and information of a plurality of the predetermined positions in the outer space, thereby generating a map indicating a distribution of an entire electromagnetic wave source including a ground surface and the outer space; and (c) a step of outputting, by an output unit, the map generated in the step (b).

According to the invention, it is possible to implement an electromagnetic wave information processing device and an electromagnetic wave information processing method capable of projecting measurement and estimation information of electromagnetic waves distributed in an omnidirection on the earth and in the outer space onto an entire celestial sphere surface or an entire ground surface effectively and at low cost through acquisition of local omnidirectional feature information, and further capable of estimating the entire (entire celestial sphere surface and entire ground surface) data from local data. Problems, configurations, and effects other than those described above will be clarified by the following description of embodiments.

### BRIEF DESCRIPTION OF THE DRAWINGS

FIG. 1 is a flowchart showing an entire flow of an electromagnetic wave information processing method according to Embodiment 1 of the invention.

FIG. 2 is a diagram showing an example of display of local omnidirectional features.

FIG. 3 is a diagram showing an example of display of omnidirectional features of a ground surface and an inertial space.

FIG. 4 is a diagram showing an example of display of omnidirectional features of the ground surface and a geocentric celestial sphere surface.

FIG. 5 is a block diagram showing a schematic configuration of an electromagnetic wave information processing device according to Embodiment 1 of the invention.

FIG. 6 is a diagram schematically showing a processing flow (correlation method) of a calculation unit 2 in FIG. 5.

FIG. 7 is a diagram showing a modification of FIG. 6.

FIG. 8 is a flowchart showing details of a measurement processing content in a calculation device of the electromagnetic wave information processing device.

FIG. 9 is a flowchart showing a processing content of a basis number and basis coefficient calculation unit.

FIG. 10 is a flowchart showing a processing content of an electromagnetic wave information conversion unit.

FIG. 11 is a diagram schematically showing a processing flow in a learning phase and an operation phase.

FIG. 12 is a diagram showing an example of a display unit of an earth surface map and an outer space map.

FIG. 13 is a diagram showing an example of the display unit of the earth surface map and the outer space map.

FIG. 14 is a flowchart showing a processing flow of observation efficiency improvement by an observation and satellite control task generation unit.

FIG. 15 is a block diagram showing a configuration example of the observation and satellite control task generation unit.

FIG. 16 is a diagram showing an example of an observation task list and a satellite control task list.

FIGS. 17A to 17C are diagrams showing an example of a simulation result when any radio wave source distribution is approximated by a spherical harmonics.

### DESCRIPTION OF EMBODIMENTS

Hereinafter, embodiments of the invention will be described with reference to the drawings. In the drawings, the same configurations are denoted by the same reference signs, and detailed description of repeating parts is omitted.

In addition, hereinafter, “local” refers to a position where a measurement signal input to an electromagnetic wave information processing device is acquired, that is, a position where a satellite is present.

A “spacecraft coordinate system” is a coordinate system based on an axis fixed to a spacecraft, and is also referred to as a Body coordinate system. A “geocentric coordinate system” is a coordinate system centered on the earth, and is used to describe satellite motion along the earth orbit.

### Embodiment 1

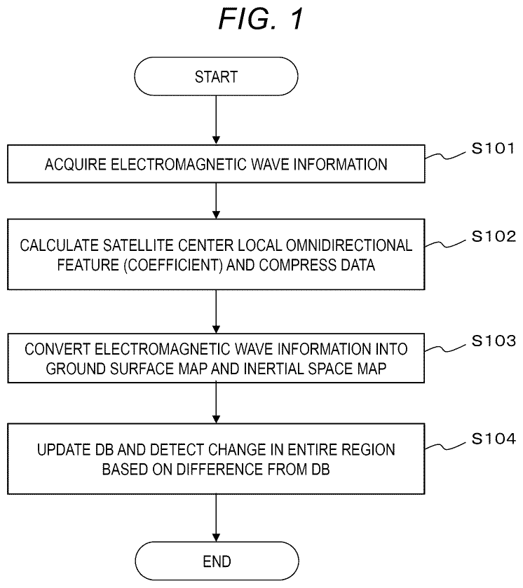

An electromagnetic wave information processing device and an electromagnetic wave information processing method according to Embodiment 1 of the invention will be described with reference to FIGS. 1 to 17.

FIG. 1 is a flowchart showing an entire flow of the electromagnetic wave information processing method according to the embodiment.

As shown in FIG. 1, in the electromagnetic wave information processing method according to the embodiment, when the electromagnetic wave information processing device starts the processing, first, in step S101, electromagnetic wave information is acquired.

Next, in step S102, a satellite center local omnidirectional feature (coefficient) is calculated, and the data is compressed.

Next, in step S103, the electromagnetic wave information is converted into a ground surface map and an inertial space map.

Finally, in step S104, a database (DB) is updated, and a change in the entire region is detected (estimated) based on a difference from data stored in the database (DB), and the processing ends.

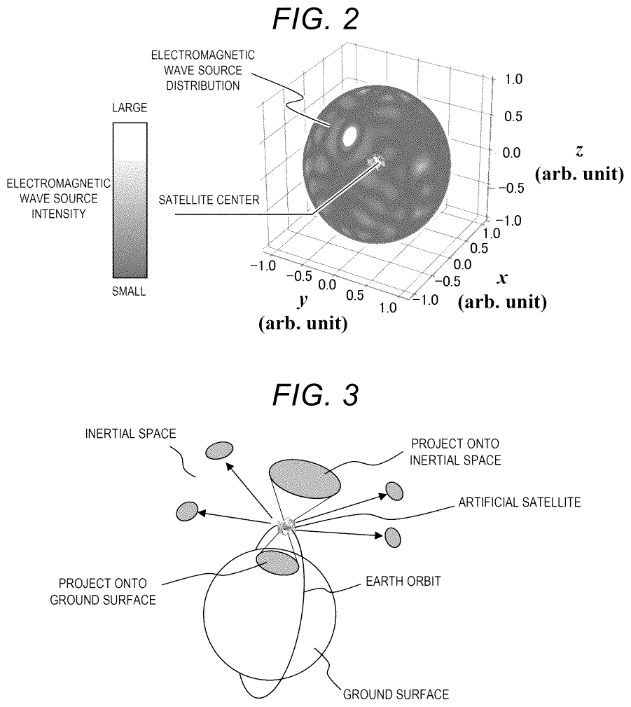

FIG. 2 is a diagram showing a display example of the local omnidirectional feature. This is an example in which the satellite center is disposed at an origin of an x-y-z space regarded as the inertial space, and a spherical surface centered on a satellite position is stereoscopically displayed. On a spherical surface corresponding to an azimuth angle and an elevation angle (depression angle) when viewed from the satellite center, an intensity of an arrival electromagnetic wave source from the corresponding direction is expressed on the spherical surface by color shading. Scales of x, y, z, and an electromagnetic wave source intensity is arbitrary unit.

As described above, “local” is a position where the measurement signal input to the electromagnetic wave information processing device is acquired. In a coordinate system centered on the local (for example, a satellite), a basis function (for example, a spherical harmonics) for representing a distribution of the arrival electromagnetic wave sources is referred to as a “local basis function”. Further, an omnidirectional feature observed locally (that is, a coefficient of the local basis function) is referred to as a “local omnidirectional feature”. In particular, when the “local” refers to the position where a satellite is present, the omnidirectional feature is referred to as a “satellite center local omnidirectional feature”. An omnidirection is defined as “any direction in an azimuth angle range of 0 degrees to 360 degrees and an elevation angle (or depression angle) range of −90 degrees to 90 degrees (corresponding to all points on the spherical surface)”.

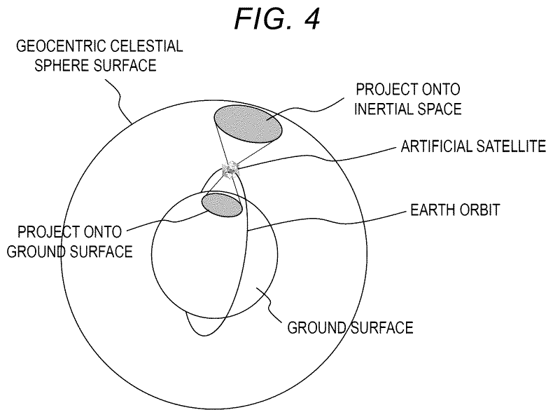

FIG. 3 is a diagram showing an example of display of omnidirectional features of the ground surface and the inertial space.

As shown in FIG. 3, by measuring a distance to an object by multichannel (Ch) and triangulation, not only a celestial sphere surface (direction) but also three-dimensional mapping is possible.

For example, by combining with a satellite orbit information database (DB), it is effective in grasping an active state and grasping a debris state of the satellite as a radiation source. An entire state quantity can be quickly estimated from local observation (local state quantity) by using a difference from the data stored in the database (DB) or a local and entire learning device/model. Change detection has an advantage that it can be performed even when a resolution is low. It is also possible to generate a task of directing observation to a region of interest after the change detection (after extraction of the region of interest).

FIG. 4 is a diagram showing an example of display of omnidirectional features of the ground surface and a geocentric celestial sphere surface.

As shown in FIG. 4, by projecting measurement and estimation information of electromagnetic waves distributed in an omnidirection on the earth and in the outer space onto the inertial space on the ground surface or the geocentric celestial sphere surface, the entire state quantity can be quickly estimated from the local observation (local state quantity) using the difference from the data stored in the satellite orbit information database (DB) or the local and entire learning device/model.

Hereinafter, a specific configuration example of the electromagnetic wave information processing device and a method thereof will be described.

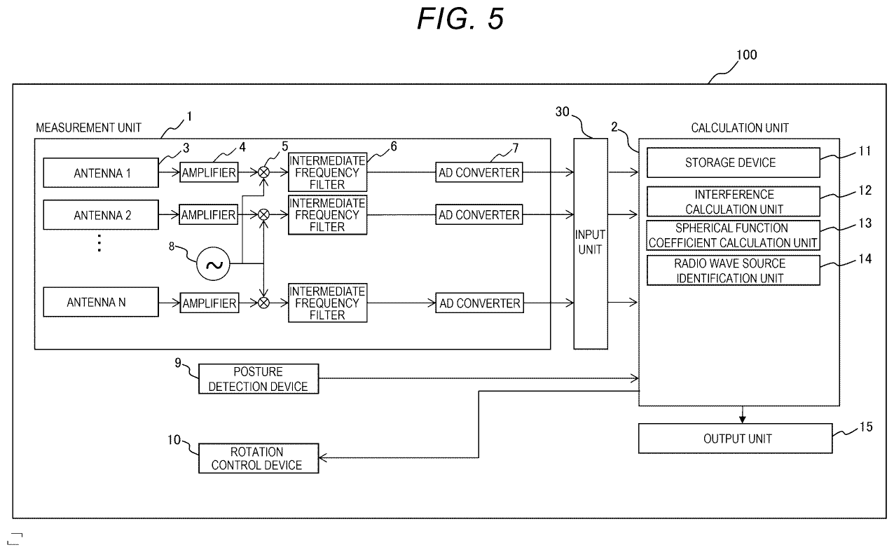

FIG. 5 is a block diagram showing a schematic configuration of an electromagnetic wave information processing device 100 according to the embodiment.

As shown in FIG. 5, the electromagnetic wave information processing device 100 according to the embodiment includes, as main components, a measurement unit 1, a calculation unit 2, a posture detection device 9, a rotation control device 10, and an output unit 15.

The measurement unit 1 includes a plurality of antennas 3, a plurality of amplifiers 4 corresponding to the respective antennas 3, a plurality of mixers 5 corresponding to the respective amplifiers 4, a plurality of intermediate frequency filters 6 corresponding to the respective mixers 5, a plurality of AD converters 7 corresponding to the respective intermediate frequency filters 6, and a local oscillator 8.

The calculation unit 2 includes a storage device 11, an interference calculation unit 12, a spherical function coefficient calculation unit 13, and a radio wave source identification unit 14.

Similarly to a principle used in an FM receiver or the like, the measurement unit 1 integrates a frequency of the local oscillator 8 to a target frequency by the mixer 5, and applies the intermediate frequency filter 6 to extract a difference frequency (intermediate frequency). The conversion into a low frequency facilitates subsequent processing. Thereafter, AD conversion is performed by the AD converter 7 and input to the calculation unit 2 which is a calculation device.

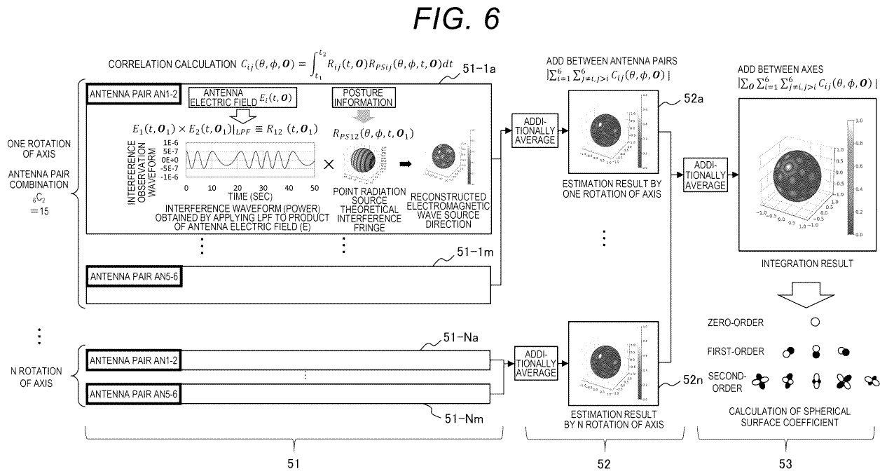

FIG. 6 is a diagram schematically showing a processing flow (correlation method) of the calculation unit 2 in FIG. 5. FIG. 6 shows a processing example of reconstruction of the electromagnetic wave source in the radio wave source identification unit 14.

Processing units of FIG. 6 include a correlation calculation unit 51, an antenna pair addition unit 52, and an inter-axis addition unit 53.

Among them, the correlation calculation unit 51 is configured for each rotation of an axis and for each antenna pair, and therefore, processing of all antenna pair combination numbers (for example, ₆C₂=15 when the number of antennas is 6) is performed for one rotation of the axis. Here, one rotation of the axis is denoted by 51-1, and is denoted by 51-1m to distinguish 15 antenna pair combinations. m is a maximum of 15.N rotation of the axis is denoted by 51-Na to 51-Nm.

In FIG. 6, the processing of 51-1a is shown as a representative example. As a result, the processing in the correlation calculation unit 51 executes the following Equation (1). Here, a reconstructed electromagnetic wave source direction is estimated as a product of an antenna electric field Ei(t, O) and posture information R_{PSij}(θ, Φ, t, O).

$$\begin{matrix}Math . 1 & \\ {C}_{i j} ( θ , ϕ , O ) = {\int }_{{t}_{1}}^{{t}_{2}} {R}_{i j} ( t , O ) {R}_{PSij} ( θ , ϕ , t , O ) dt & ( 1 )\end{matrix}$$

The antenna electric field Ei(t, O) is obtained as an interference waveform obtained by applying a low-pass filter (LPF) to the product of the antenna electric field Ei(t, O), and the posture information R_{PSij}(θ, Φ, t, O) is obtained as a point radiation source theoretical interference fringe. In addition, the reconstructed electromagnetic wave source direction is visualized by shading on the spherical surface, and the larger the brightness difference between a bright portion and a dark portion, the higher the reliability of the information.

The reconstructed electromagnetic wave source direction obtained for each rotation of the axis and for each antenna pair is obtained by additionally averaging for each axis in the antenna pair addition unit 52 (52a to 52n). This processing is obtained by the following Equation (2).

$$\begin{matrix}Math . 2 & \\ \vert {\sum }_{i = 1}^{6} {\sum }_{j \neq i , j > i}^{6} {C}_{ij} ( θ , ϕ , O ) \vert & ( 2 )\end{matrix}$$

Further, the reconstructed electromagnetic wave source direction obtained by additionally averaging for each axis is additionally averaged by the inter-axis addition unit 53 to obtain a comprehensive result. This processing is obtained by the following Equation (3).

$$\begin{matrix}Math . 3 & \\ \vert {\sum }_{O} {\sum }_{i = 1}^{6} {\sum }_{j \neq i , j > i}^{6} {C}_{ij} ( θ , ϕ , O ) \vert & ( 3 )\end{matrix}$$

Details of the above processing contents are as follows.

First, the electric field Ei measured by the i-th antenna when the k-th rotation is performed depends on a time t and a posture of the spacecraft by a rotation operation k, and is obtained as time-series data of a voltage value obtained by an analog-digital converter (AD converter 7) in the subsequent stage of the antenna.

An interference waveform Rᵢⱼ in a pair of the i-th antenna and the j-th antenna is calculated by, for example, performing integrating processing on the electric field Eᵢ and an electric field Eⱼ and applying the low-pass filter (LPF). The interference waveform may be obtained by calculation processing using digital data after the AD conversion, or the interference waveform may be obtained by analog integrating processing using a mixer or the like in an electronic circuit and then subjected to AD conversion processing through the low-pass filter (LPF).

Next, a theoretical interference fringe when assuming a point radiation source is obtained from a positional relationship of the antenna pair obtained from the posture of the spacecraft or a baseline vector which is a vector connecting the antenna pair. By mapping, on the spherical surface, an interference intensity when electromagnetic waves having a predetermined frequency arrive from the point radiation source in each direction (azimuth angle, elevation angle) at infinity, a theoretical interference fringe whose pattern changes in time series is obtained.

After the above processing, the electromagnetic wave source can be reconstructed by superimposing the theoretical interference fringes at each time using an interference intensity change at each time as a weight.

As an effect of the above processing, it is possible to reduce a ghost (artifact) by reconstructing the electromagnetic wave source using data acquired by a plurality of rotation operations. Further, since the number of decomposable electromagnetic wave sources increases by using the rotation, a large number of electromagnetic wave sources can be reconstructed.

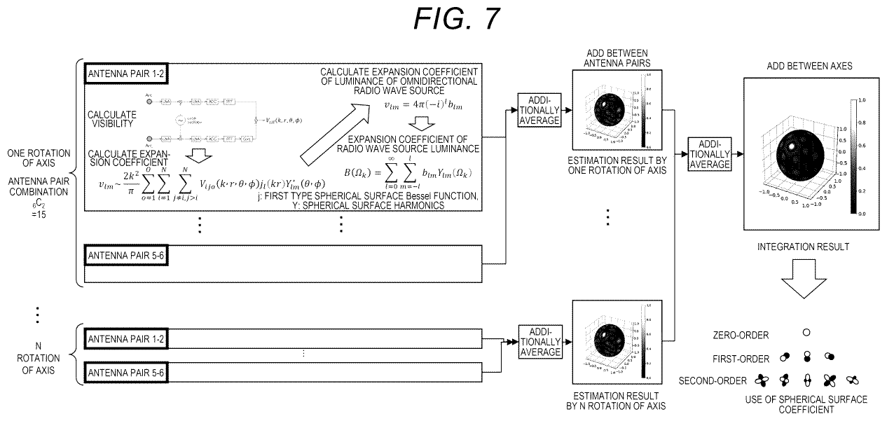

FIG. 7 is a diagram showing a modification of FIG. 6, and schematically shows a processing flow (spherical harmonics method) of the calculation unit 2 of FIG. 5.

Here, an expression of an omnidirectional radio wave source using the spherical harmonics will be described.

In a spacecraft coordinate system centered on a spacecraft including a three-dimensional array antenna, a radio wave source brightness at a wavenumber k=|k| is represented by B(Ωₖ). Here, k is a wavenumber vector, Ωₖ=(θₖ, Φₖ) is a solid angle, θₖ is an elevation angle, and Φₖ is an azimuth angle (·k is a spherical component of wavenumber vector). When a phase reference is set to an origin of the spacecraft coordinate system, a visibility V which is a wavenumber region expression of the radio wave source brightness is given by the following Equation (4) (T. Carozzi, 2015, Monthly Notices of the Royal Astronomical Society: Letters 451).

$$\begin{matrix}Math . 4 & \\ V ( r , k ) = \int B ( {Ω}_{k} ) exp ( - ik \cdot r ) d {Ω}_{k} & ( 4 )\end{matrix}$$

Here, r represents a position vector of a visibility region. In order to express Equation (4) using the spherical harmonics, the visibility V(r, k), the radio wave source brightness B (Ωₖ), and an exponential function part exp(−ik·r) are expressed as the following Equation (5) to Equation (7).

$$\begin{matrix}Math . 5 & \\ V ( r , k ) = {\sum }_{l = 0}^{∞} {\sum }_{m = - l}^{l} {v}_{l m} {j}_{l} ( k r ) {Y}_{l m} ( {θ}_{r} , {ϕ}_{r} ) & ( 5 )\end{matrix}$$

$$\begin{matrix}Math . 6 & \\ B ( {Ω}_{k} ) = {\sum }_{l = 0}^{∞} {\sum }_{m = - l}^{l} {b}_{l m} {Y}_{l m} ( {Ω}_{k} ) & ( 6 )\end{matrix}$$

$$\begin{matrix}Math . 7 & \\ exp ( - ik \cdot r ) = 4 π {\sum }_{l = 0}^{∞} {\sum }_{m = - l}^{l} {( - i )}^{l} {j}_{l} ( k r ) {Y}_{lm} ( {θ}_{r} , {ϕ}_{r} ) {Y}_{l m}^{*} ( {Ω}_{k} ) & ( 7 )\end{matrix}$$

In Equation (5), Vₗₘ is an expansion coefficient of the visibility, r=|r| is a radius, jₗ(kr) is a first type spherical Bessel function, Yₗₘ(Ω) is a spherical harmonics (l and m are an azimuth quantum number and a magnetic quantum number, respectively), and a subscript ·ᵣ means a spherical coordinate expression of the position vector r. In addition, in Equation (6), bₗₘ is an expansion coefficient of the radio wave source brightness, and Equation (7) is obtained by expressing, by the spherical harmonics, an electric field subjected to plane wave expansion.

By substituting Equations (5), (6), and (7) into Equation (4), a relationship between the visibility and the radio wave source brightness can be expressed as the following Equation (8) using the expansion coefficient of the spherical harmonics.

$$\begin{matrix}Math . 8 & \\ {v}_{l m} = 4 {π ( - i )}^{l} {b}_{l m} & ( 8 )\end{matrix}$$

Further, the expansion coefficient Vim of the spherical harmonics of the visibility obtained by observation by the three-dimensional array antenna is expressed by the following Equation (9) using the number N of antenna channels and a total number O of minute rotation operations.

$$\begin{matrix}Math . 9 & \\ {v}_{l m} ∼ \frac{2 {k}^{2}}{π} {\sum }_{O = 1}^{O} {\sum }_{i = 1}^{N} {\sum }_{j \neq i , j > i}^{N} {V}_{ijO} ( k , r , θ , ϕ ) {j}_{l} ( kr ) {Y}_{l m}^{*} ( θ , ϕ ) & ( 9 )\end{matrix}$$

Thus, by substituting Equation (9) into Equation (8), the expansion coefficient bₗₘ of the brightness of the omnidirectional radio wave source is obtained from the expansion coefficient Vₗₘ of the spherical harmonics of the visibility obtained by the observation by the three-dimensional array antenna. Finally, the radio wave source brightness can be reconstructed by substituting bₗₘ into Equation (6).

Here, the first type spherical Bessel function jₗ(kr) is expressed by the following Equation (10).

$$\begin{matrix}Math . 10 & \\ {j}_{l} ( kr ) = \sqrt{\frac{π}{2 ke}} {\sum }_{m = 0}^{∞} \frac{{( - 1 )}^{m}}{m ! Γ ( m + l + 1.5 )} {( \frac{k r}{2} )}^{2 m + l + 0.5} & ( 10 )\end{matrix}$$

β(z) is a gamma function and is expressed by the following Equation (11). e is a basis of a natural logarithm.

$$\begin{matrix}Math . 11 & \\ Γ ( z ) = {\int }_{0}^{∞} {t}^{z - 1} {e}^{- t} dt & ( 11 )\end{matrix}$$

The spherical harmonics Yₗₘ(Ω)=Yₗ^{m}(θ, Φ) is expressed by the following Equation (12).

$$\begin{matrix}Math . 12 & \\ {Y}_{k}^{m} ( θ , ϕ ) = {( - 1 )}^{\frac{m + \vert m \vert}{2}} \sqrt{\frac{2 k + 1}{4 π} \frac{( k - \vert m \vert ) !}{{( k + \vert m \vert )}^{1}}} {P}_{k}^{\vert m \vert} ( cos θ ) {e}^{i m ϕ} & ( 12 )\end{matrix}$$

Here, m is an integer, k≥|m|, Y*ₗₘ represents a complex conjugate (obtained by inverting a sign of an imaginary part), and Pₖ^{m}(t) is an associated Legendre polynomial shown in Equation (13).

$$\begin{matrix}Math . 13 & \\ {P}_{k}^{m} ( t ) = \frac{1}{{2}^{k}} {( 1 - {t}^{2} )}^{\frac{m}{2}} {\sum }_{j = 0}^{( k - m ) / 2} \frac{{( - 1 )}^{j} ( 2 k - 2 i ) !}{j ! ( k - j ) ! ( k - 2 j - m ) !} {t}^{k - 2 j - m} & ( 13 )\end{matrix}$$

That is, Pₖ^{m}(t) is a solution of an associated Legendre equation shown in Equation (14).

$$\begin{matrix}Math . 14 & \\ ( 1 - {t}^{2} ) {γ}^{″} ( t ) - 2 {ty}^{′} ( t ) + [ k ( k + 1 ) - \frac{{m}^{2}}{1 - {t}^{2}} ] y ( t ) = 0 & ( 14 )\end{matrix}$$

It is known that an associated Legendre equation has a solution only when Equation (13) is satisfied. In Equation (9), the order (azimuth quantum number, magnetic quantum number) of the spherical harmonics to be calculated can be changed according to a distribution state of a radio wave source to be measured and a necessary spatial resolution.

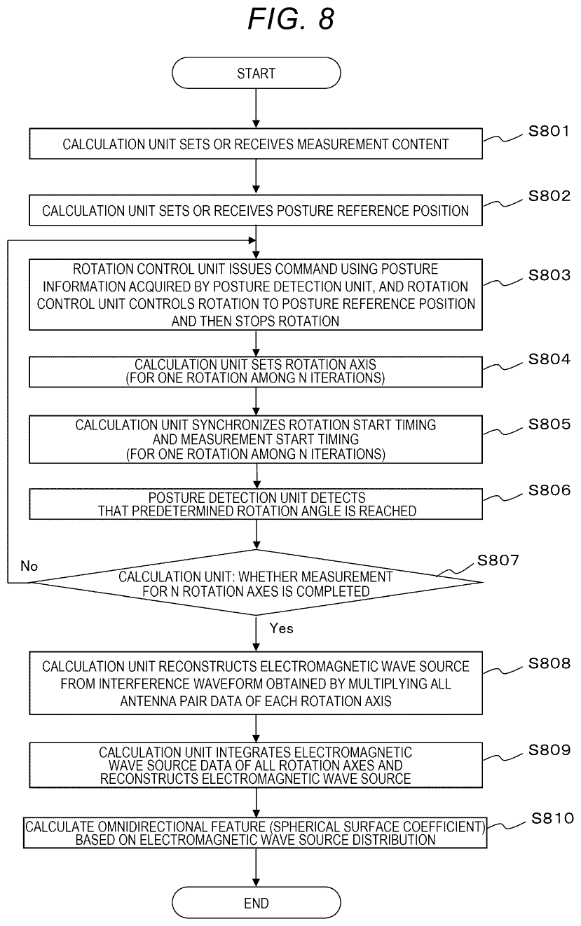

FIG. 8 is a flowchart showing details of a measurement processing content in the calculation device of the electromagnetic wave information processing device 100.

In the example of FIG. 8, when the calculation device of the electromagnetic wave information processing device 100 starts processing, first, in steps S801 and S802, the calculation unit acquires a measurement content and a posture reference position (direction).

In FIG. 8, as the processing content of step S803, a series of procedures for executing rotation measurement is specifically described as step S804 to step S807.

In step S803, the rotation control device 10 issues a command using posture information acquired by the posture detection device 9, and the rotation control device 10 controls the rotation to the posture reference position (direction) and then stops the rotation.

Next, in step S804, the calculation unit sets a rotation axis for one rotation among N iterations, and in step S805, the calculation unit synchronizes a rotation start timing and a measurement start timing for one rotation among the N iterations. Under this condition, in step S806, the posture detection device 9 detects that a predetermined rotation angle is reached.

The processing from step S803 to step S806 described above is continuously performed by changing a condition until the measurement for N rotation axes is completed in step S807.

Thereafter, in step S808, the calculation unit performs processing of calculating an interference waveform by associating each piece of posture and time information with an electric field waveform measured by each antenna and multiplying a signal for each antenna pair, and processing of calculating or reading a theoretical interference intensity change pattern from a posture change, and at this time, processing of reconstructing an electromagnetic wave source from the interference waveform obtained by multiplying all antenna pair data of each rotation axis.

Further, in step S809, the calculation unit multiplies the interference waveform at each time by the theoretical interference intensity change pattern corresponding to each time and performs integration in a time direction, thereby performing processing of reconstructing the electromagnetic wave source and processing of integrating electromagnetic wave source data of all the rotation axes to perform processing of reconstructing the electromagnetic wave source.

In the specific measurement processing shown in FIG. 8, the posture detection device 9 recognizes a rotation angle, sequentially controls the start and stop of rotation on a plurality of axes, reconstructs the electromagnetic wave source using the interference waveform of the antenna pair used for analysis for each rotation axis, and reconstructs the electromagnetic wave source by aligning all the rotation axes.

Finally, in step S810, an omnidirectional feature (spherical coefficient) is calculated based on the electromagnetic wave source distribution, and the processing ends.

By approximating omnidirectional distribution information using a basis of a spherical function, a data amount can be effectively compressed.

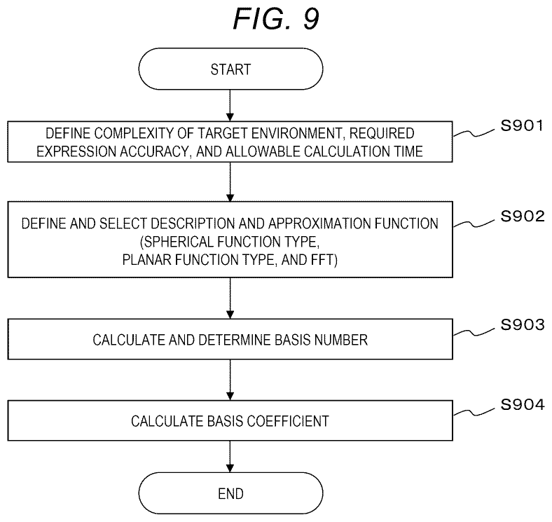

FIG. 9 is a flowchart showing a processing content of a basis number and basis coefficient calculation unit.

As shown in FIG. 9, when the basis number and basis coefficient calculation unit starts processing, first, in step S901, complexity of a target environment, required expression accuracy, and an allowable calculation time are defined.

Next, in step S902, a description and an approximation function are defined and selected. Examples thereof include a spherical function type, a planar function type, and fast Fourier transform (FFT).

Next, in step S903, the basis number is calculated and determined.

Finally, in step S904, the basis coefficient is calculated, and the processing ends.

The order of the basis function is set to be larger as the complexity of the target environment is larger, the required expression accuracy is higher, and the allowable calculation time is longer. The description and approximation function is set based on a spherical harmonics coefficient, a spherical Bessel function coefficient, a spherical Neumann function coefficient, a spherical Hankel function coefficient, a spherical wavelet coefficient, a spherical Haar basis, an azimuth/elevation angle discretization coefficient, a one-dimensional to three-dimensional FFT coefficient, a learning device, or the like. Some orders are set, a calculation time and error evaluation are performed, and a basis number of a matching condition is calculated and determined. Then, the basis coefficient is calculated based on the above conditions.

Since complexity of a model can be adjusted according to a scale and an allowable time, the speed can be increased when accuracy is not required, and a model with higher expressiveness can be used when accuracy is required. A basis of a plane wave may be used. When it is desired to increase the speed, FFT processing may be performed. When a direction is determined to some extent, the spherical coefficient is good. In detail, a method of cutting by a plane may be used.

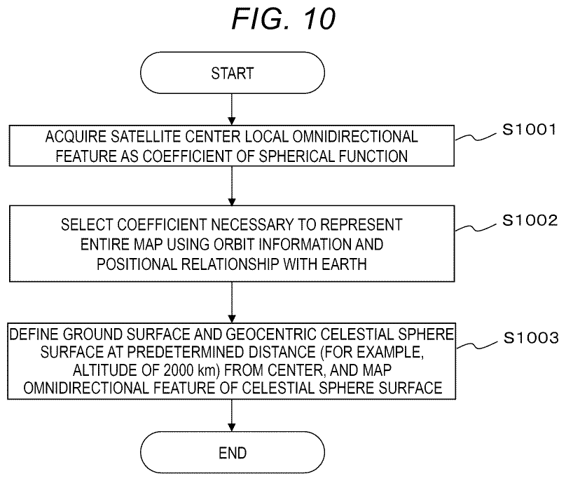

FIG. 10 is a flowchart showing a processing content of an electromagnetic wave information conversion unit.

As shown in FIG. 10, when the electromagnetic wave information conversion unit starts processing, first, in step S1001, the satellite center local omnidirectional feature is acquired as a coefficient of the spherical function.

Next, in step S1002, a coefficient of a local spherical harmonics, orbit information, and a positional relationship with the earth are used to select only coefficients having a high contribution of a predetermined threshold, and then the coefficients are projected and converted as features at the ground surface and a predetermined altitude (for example, an altitude of 2000 km).

Finally, in step S1003, the coefficients are selected, the projected and converted features at the ground surface and the predetermined altitude are added, the coefficient of the spherical function is calculated, thereby acquiring and mapping the omnidirectional feature of the celestial sphere surface, and the processing ends.

By selecting a coefficient having a high contribution rate, the data amount can be further compressed. In addition, the change can be quickly determined by updating the database (DB) and comparing the database (DB) with the acquired database (DB).

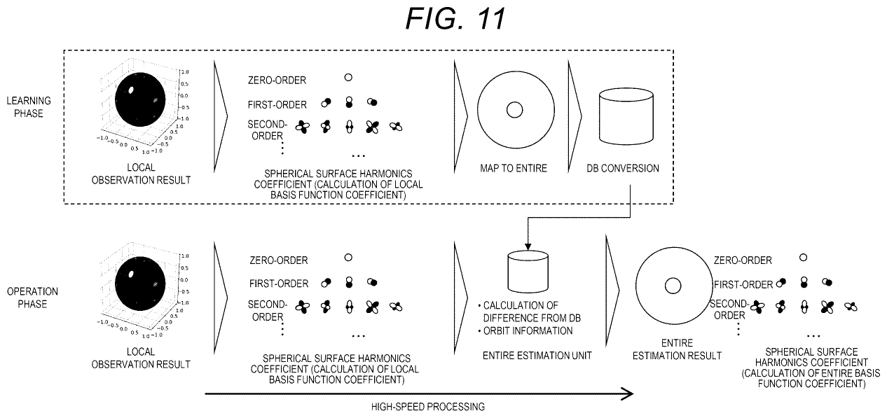

FIG. 11 is a diagram schematically showing a processing flow in a learning phase and an operation phase.

In the learning phase, the spherical harmonics coefficients are calculated based on the orbit information and a local observation result, or the visibility observed by each antenna pair, an entire map is generated, and the entire map is generated as a database that holds a relationship (model) between the local observation result and the entire map.

In the operation phase, after the spherical harmonics coefficient is calculated based on the orbit information and the local observation result, the entire can be estimated using the database, and high-speed calculation can be performed. The entire estimation result may be calculated using a difference from the database (DB). In this case, it is desirable to adopt the entire map in which the difference is the smallest. After the entire estimation, an entire basis function coefficient is calculated.

By using the coefficient of the spherical function, the electromagnetic wave information can be compressed to a smaller amount of information. Further, it is possible to perform the entire estimation and the change and abnormality detection in a short time by efficiently performing database (DB) conversion, extracting a difference from the local observation result using the database (DB), and performing the entire estimation.

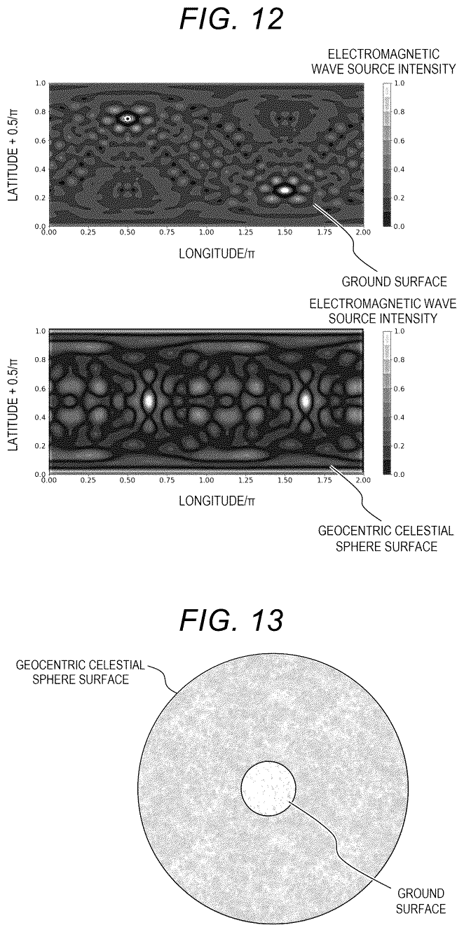

FIGS. 12 and 13 are diagrams showing examples of display units of an earth surface map and an outer space map.

The earth surface map and the outer space map of the electromagnetic wave information are displayed, for example, in the forms shown in FIGS. 12 and 13. A map for each frequency of electromagnetic waves may be displayed.

The effect of displaying on the geocentric celestial sphere surface is that it is effective in extracting a region of interest from a change point in an earth orbit mission. This is also effective in generating an observation task and a satellite control task. In addition, by displaying on the entire sphere, the entire can be estimated from local observation. In addition, landing can be performed with high accuracy. In addition, it is also effective to know whether it is a place where it is difficult for radio waves to reach. By using this, a communicable area can be known in advance.

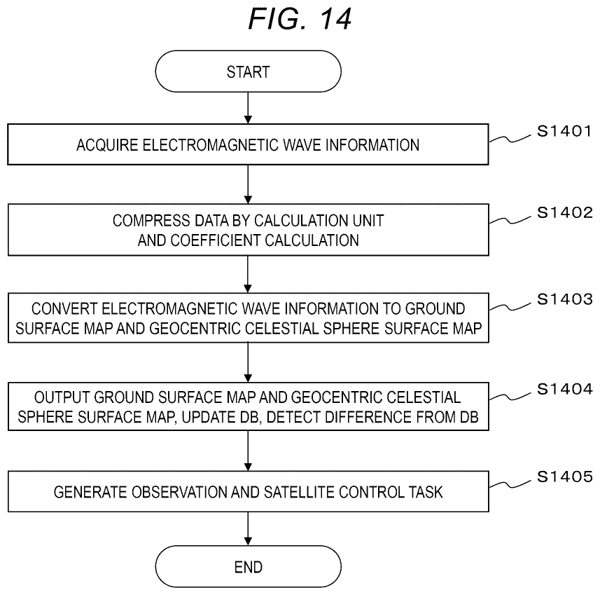

FIG. 14 is a flowchart showing a processing flow of observation efficiency improvement by an observation and satellite control task generation unit.

As shown in FIG. 14, when the observation and satellite control task generation unit of the electromagnetic wave information processing device 100 starts processing, first, in step S1401, electromagnetic wave information is acquired.

Next, in step S1402, data by a calculation result in the calculation unit 2 and the coefficient calculation is compressed.

Next, in step S1403, the electromagnetic wave information is converted into a ground surface map and a geocentric celestial sphere surface map.

Next, in step S1404, the ground surface map and the geocentric celestial sphere surface map are output to update the database (DB), and a difference from the data stored in the database (DB) is detected.

Finally, in step S1405, an observation task and satellite control task is generated, and the processing ends.

According to the processing flow shown in FIG. 14, it is possible to quickly grasp radio wave conditions of a satellite and a celestial body and to quickly switch the observation by generating a new control task for improving the efficiency of the observation. It is also expected that the radio wave condition can be grasped more quickly.

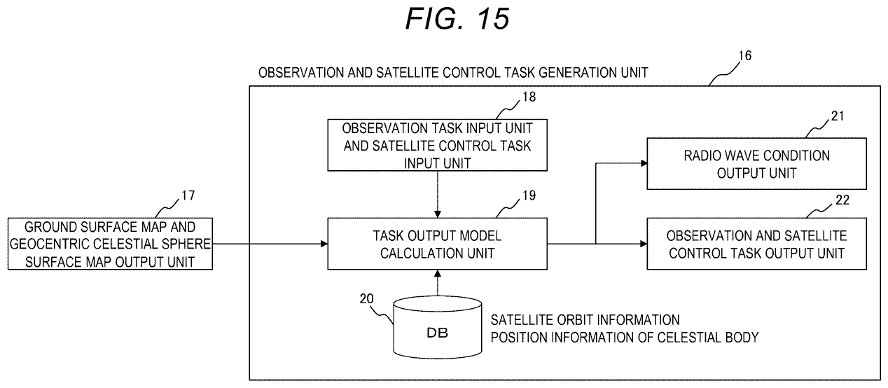

FIG. 15 is a block diagram showing a configuration example of an observation and satellite control task generation unit 16.

As shown in FIG. 15, the observation and satellite control task generation unit 16 generates an observation task and satellite control task based on information received from a ground surface map and geocentric celestial sphere surface map output unit 17.

The observation and satellite control task generation unit 16 includes an observation task input unit and satellite control task input unit 18, a task output model calculation unit 19, a database (DB) 20, a radio wave condition output unit 21, and an observation and satellite control task output unit 22.

The task output model calculation unit 19 calculates a difference between satellite orbit information or position information data of the celestial body stored in the database (DB) 20 and the observed geocentric celestial sphere surface map, receives inputs of the observed ground surface map, the observation task, and the satellite control task, and calculates the radio wave condition or the satellite control task. This calculation may be performed by, for example, an input or output model obtained in advance by machine learning.

The database (DB) 20 stores, for example, satellite orbit information, position information of a celestial body, other space object observation information, or the like by a North American Aerospace Defense Command (NORAD).

The radio wave condition output unit 21 outputs an activity state of another satellite and an activity state of a celestial body.

A basic processing flow in the observation and satellite control task generation unit 16 and an effect thereof are as described with reference to the flowchart of FIG. 14.

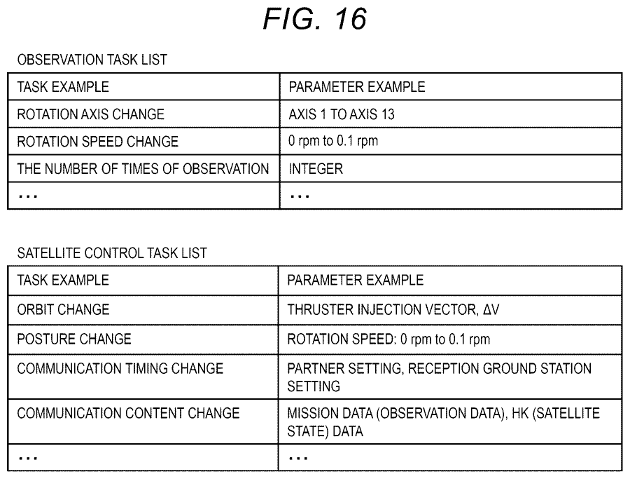

FIG. 16 is a diagram showing an example of an observation task list and a satellite control task list.

In the observation task list, for example, parameters such as axes 1 to 13, 0 rpm to 0.1 rpm, and integers are listed for tasks such as rotation axis change, rotation speed change, and the number of times of observation.

In the satellite control task list, for example, parameters such as a thruster injection vector, ΔV, a rotation speed of 0 rpm to 0.1 rpm, a partner setting, a reception ground station setting, mission data (observation data), and HK (satellite state) data are listed for tasks such as orbit change, posture change, communication timing change, and communication content change.

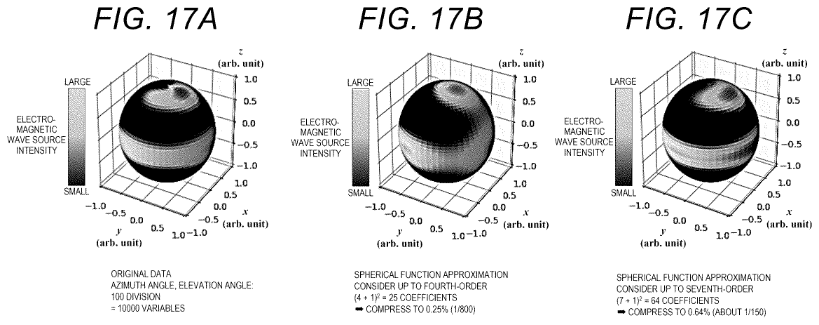

FIG. 17 is a diagram showing an example of a simulation result when any radio wave source distribution is approximated by a spherical harmonics. FIG. 17 shows an example in which any radio wave source distribution is approximated by a linear combination of the spherical harmonics.

FIG. 17A shows a distribution of 10000 variables obtained by dividing each of the azimuth angle and the elevation angle (or depression angle) by 100. This distribution is approximated by using a total of 25 coefficients up to the fourth-order of the spherical harmonics as bases, as shown in FIG. 17B. At this time, it is compressed to 0.25%, that is, 1/400.

Further, for more accurate approximation, a total of 64 coefficients up to the seventh-order are used as bases, and the approximation is shown in FIG. 17C. At this time, it is compressed to 0.64%, that is, 1/150.

Since data can be compressed in this manner, an amount of downlink can be reduced when on-board calculation is performed in a satellite, a storage capacity can be reduced when data is handled, and cost can be reduced.

As described above, the electromagnetic wave information processing device according to the embodiment includes: a measurement unit configured to measure electromagnetic waves incident on a spacecraft from substantially an omnidirection; an input unit configured to receive a measurement result from the measurement unit; a calculation unit configured to perform calculation based on information received by the input unit; and an output unit configured to output a calculation result in the calculation unit. The calculation unit calculates, based on the measurement result received by the input unit, a local omnidirectional feature which is a coefficient of a local basis function indicating a distribution of the electromagnetic waves received by the input unit in a spacecraft coordinate system centered on the spacecraft at a predetermined position in an outer space, and calculates an entire omnidirectional feature which is a coefficient of an entire basis function based on a plurality of the local omnidirectional features and information of a plurality of the predetermined positions in the outer space, thereby generating a map indicating a distribution of an entire electromagnetic wave source including a ground surface and the outer space. The output unit outputs the map. Here, a basis function (for example, a spherical harmonics) for representing a distribution of arrival electromagnetic wave sources, a radio wave source distribution on the ground surface, or the like in a coordinate system centered on the earth (a geocentric coordinate system) is referred to as an “entire basis function”.

The electromagnetic wave information processing device according to the embodiment is an electromagnetic wave information processing device mounted on a spacecraft. The electromagnetic wave information processing device includes: a measurement unit configured to measure electromagnetic waves incident from a substantially omnidirection; a calculation unit configured to perform calculation based on information measured by the measurement unit; and an output unit configured to output a calculation result in the calculation unit. The calculation unit calculates, based on an electromagnetic wave measurement result measured by the measurement unit, a local omnidirectional feature which is a coefficient of a local basis function indicating a distribution of the electromagnetic waves measured by the measurement unit in a spacecraft coordinate system centered on the spacecraft at a predetermined position in an outer space, and calculates an entire omnidirectional feature which is a coefficient of an entire basis function based on a plurality of the local omnidirectional features and information of a plurality of the predetermined positions in the outer space, thereby generating a map indicating a distribution of an entire electromagnetic wave source including a ground surface and the outer space. The output unit outputs the map.

The electromagnetic wave information processing device further includes an entire estimation unit. The calculation unit generates a database that holds a relationship between the map and the local omnidirectional feature at the plurality of predetermined positions in the outer space. The entire estimation unit calculates a local omnidirectional feature during operation in a new spacecraft coordinate system, detects a difference between the local omnidirectional feature and the local omnidirectional feature during operation by comparing the local omnidirectional feature during operation with the database, and estimates a change in the map.

The local omnidirectional feature is a spherical function coefficient.

The calculation unit calculates an observation task and a satellite control task by using a ground surface map and a geocentric celestial sphere surface map of the electromagnetic waves, and the output unit outputs the observation task and the satellite control task that are calculated by the calculation unit.

By expressing the omnidirectional feature using the coefficient of the basis function, the data amount to be held can be compressed. Accordingly, a required amount of satellite communication can be reduced, and downlink can be performed in a short path or in a short visible time.

In addition, by accumulating a measurement result of the electromagnetic wave source in advance in the learning phase and generating a database of the measurement result, an entire image of radio wave information can be grasped from local measurement, and the entire image can be grasped more quickly.

In addition, by outputting the observation task and satellite control task, it is possible to efficiently and speedily grasp a distribution of electromagnetic wave sources in a region of interest.

The invention is not limited to the embodiments described above, and includes various modifications. For example, the embodiments described above have been described in detail to facilitate understanding of the invention, and the invention is not necessarily limited to those including all the configurations described above. A part of a configuration of a certain embodiment can be replaced with a configuration of another embodiment, and the configuration of another embodiment can be added to a configuration of a certain embodiment. A part of a configuration of each embodiment may be added to, deleted from, or replaced with another configuration.

A part or all of the configurations, functions, processing units, processing methods, or the like described above may be implemented by hardware by, for example, designing with an integrated circuit. The above configurations, functions, or the like may be implemented by software by a processor interpreting and executing a program for implementing each function. Information such as a program, a table, and a file for implementing each function can be stored in a recording device such as a memory, a hard disk, and a solid state drive (SSD), or in a recording medium such as an IC card, an SD card, and a DVD.

What is claimed is:

1. An electromagnetic wave information processing device comprising:
an input unit configured to receive a measurement result from a measurement unit that measures electromagnetic waves incident on a spacecraft from substantially an omnidirection;
a calculation unit configured to perform calculation based on information received by the input unit; and
an output unit configured to output a calculation result in the calculation unit, wherein
the calculation unit calculates, based on the measurement result received by the input unit, a local omnidirectional feature which is a coefficient of a local basis function indicating a distribution of the electromagnetic waves received by the input unit in a spacecraft coordinate system centered on the spacecraft at a predetermined position in an outer space, and calculates an entire omnidirectional feature which is a coefficient of an entire basis function based on a plurality of the local omnidirectional features and information of a plurality of the predetermined positions in the outer space, thereby generating a map indicating a distribution of an entire electromagnetic wave source including a ground surface and the outer space, and
the output unit outputs the map.

2. The electromagnetic wave information processing device according to claim 1, further comprising:
an entire estimation unit, wherein
the calculation unit generates a database that holds a relationship between the map and the local omnidirectional feature at the plurality of predetermined positions in the outer space, and
the entire estimation unit calculates a local omnidirectional feature during operation in a new spacecraft coordinate system, detects a difference between the local omnidirectional feature and the local omnidirectional feature during operation by comparing the local omnidirectional feature during operation with the database, and estimates a change in the map.

3. The electromagnetic wave information processing device according to claim 1, wherein
the local omnidirectional feature is a spherical function coefficient.

4. The electromagnetic wave information processing device according to claim 1, wherein
the calculation unit calculates an observation task and a satellite control task by using a ground surface map and a geocentric celestial sphere surface map of the electromagnetic waves, and
the output unit outputs the observation task and the satellite control task that are calculated by the calculation unit.

5. An electromagnetic wave information processing device mounted on a spacecraft, the electromagnetic wave information processing device comprising:
a measurement unit configured to measure electromagnetic waves incident from a substantially omnidirection;
a calculation unit configured to perform calculation based on information measured by the measurement unit; and
an output unit configured to output a calculation result in the calculation unit, wherein
the calculation unit calculates, based on an electromagnetic wave measurement result measured by the measurement unit, a local omnidirectional feature which is a coefficient of a local basis function indicating a distribution of the electromagnetic waves measured by the measurement unit in a spacecraft coordinate system centered on the spacecraft at a predetermined position in an outer space, and calculates an entire omnidirectional feature which is a coefficient of an entire basis function based on a plurality of the local omnidirectional features and information of a plurality of the predetermined positions in the outer space, thereby generating a map indicating a distribution of an entire electromagnetic wave source including a ground surface and the outer space, and
the output unit outputs the map.

6. The electromagnetic wave information processing device according to claim 5, further comprising:
an entire estimation unit, wherein
the calculation unit generates a database that holds a relationship between the map and the local omnidirectional feature at the plurality of predetermined positions in the outer space, and
the entire estimation unit calculates a local omnidirectional feature during operation in a new spacecraft coordinate system, detects a difference between the local omnidirectional feature and the local omnidirectional feature during operation by comparing the local omnidirectional feature during operation with the database, and estimates a change in the map.

7. The electromagnetic wave information processing device according to claim 5, wherein
the local omnidirectional feature is a spherical function coefficient.

8. The electromagnetic wave information processing device according to claim 5, wherein
the calculation unit calculates an observation task and a satellite control task by using a ground surface map and a geocentric celestial sphere surface map of the electromagnetic waves, and
the output unit outputs the observation task and the satellite control task that are calculated by the calculation unit.

9. An electromagnetic wave information processing method comprising:
(a) a step of calculating, by a calculation unit, based on an electromagnetic wave measurement result measured by a measurement unit, a local omnidirectional feature which is a coefficient of a local basis function indicating a distribution of electromagnetic waves measured by the measurement unit in a spacecraft coordinate system centered on a spacecraft at a predetermined position in an outer space;
(b) a step of calculating an entire omnidirectional feature which is a coefficient of an entire basis function based on a plurality of the local omnidirectional features and information of a plurality of the predetermined positions in the outer space, thereby generating a map indicating a distribution of an entire electromagnetic wave source including a ground surface and the outer space; and
(c) a step of outputting, by an output unit, the map generated in the step (b).
